(19) United States
(12) Patent Application Publication
(10) Pub. No.: US 2010/0051318 A1
(43) Pub. Date: Mar. 4, 2010

(54) CABLE WITH SHIELDING MEANS

(75) Inventor: Chang-Pin Wang, Taipei (TW)

Correspondence Address: SURE-FIRE ELECTRICAL CORPORATION, P.O. BOX 108-00403, TAIPEI, 106, omitted

(73) Assignee: SURE-FIRE ELECTRICAL CORPORATION

(21) Appl. No.: 12/401,654

(22) Filed: Mar. 11, 2009

Related U.S. Application Data
(63) Continuation-in-part of application No. 12/200,933, filed on Aug. 29, 2008, now abandoned.

(51) Int. Cl. H01B 11/00

(52) U.S. Cl. 174/113 R

(57) ABSTRACT

A low-capacitance and interference-free cable practical for a long-distance (over 20M) application is disclosed to include an electrical strand formed of four high-frequency A/V transmission lines, a plurality of low-frequency transmission lines and a power line, a shielding layer surrounding the electrical strand, a tin foil layer surrounding the shielding layer, a braided layer surrounding the tin foil layer and an outer plastic sheath surrounding the braided layer.

This application is a Continuation-In-Part of my patent application, Ser. No. 12/200,933, filed on Aug. 29, 2008.

### BACKGROUND OF THE INVENTION

1. Field of the Invention

The present invention relates to cables and more particularly, to a cable with shielding means that is practical for a long-distance (over 20M) application to transmit audio and video signals stably without causing any rise in capacitance.

2. Description of the Related Art

With the arrival of technological era, the living style of people is changed and, many high-tech products and techniques are continuously being developed for use in food, clothing, housing, transportation and entertainment industries. With respect to audio and video products, CDs, VCDs, LDs and DVDs are intensively used with different types of media players nowadays to replace early videotapes. In a media player system, a signal transmission cable is used for transmitting audio and video signals from the host to the speakers and the screen. A signal transmission cable for this purpose comprises different signal lines including video signal transmission lines, audio signal transmission lines and power line. These audio and video signal transmission lines and power line are arranged into a strand and then surrounded in proper order by a tin foil, a braided layer and an outer plastic sheath. Because the high-frequency and low-frequency signal transmission lines are closely arranged together, the capacitance value of the cable will be relatively increased when the cable extends relatively longer. Rising in capacitance value directly affects signal stability. When the cable extends over a predetermined distance, the transmission quality will become poor, resulting an image distortion and signal interference.

Therefore, it is desirable to provide a signal transmission cable, which is practical for a long distance application without affecting signal transmission stability.

### SUMMARY OF THE INVENTION

The present invention has been accomplished under the circumstances in view. It is one object of the present invention to provide a cable, which is practical for a long-distance application to transmit audio and video signals stably without causing any rise in capacitance. It is another object of the present invention to provide a cable, which avoids signal interference during transmission of audio and video signals.

To achieve these and other objects of the present invention, a cable comprises an electrical strand formed of four high-frequency A/V transmission lines, a plurality of low-frequency transmission lines and a power line, a shielding layer surrounding the electrical strand, a tin foil layer surrounding the shielding layer, a braided layer surrounding the tin foil layer and an outer plastic sheath surrounding the braided layer. The low-frequency transmission lines include two clock and data transmission lines surrounded by the four high-frequency A/V transmission lines. Because the clock and data transmission lines are isolated from the tin foil layer by the shielding layer, and the tin foil layer is prohibited from interfering with data transmission of the clock and data transmission lines, the cable is practical for a long distance application (over 20 meters) without causing any rise in capacitance value.

Further, the two clock and data transmission lines of the low-frequency transmission lines are surrounded by the four high-frequency A/V transmission lines, the distance between each clock and data transmission line and the tin foil layer is relatively longer than the other low-frequency transmission lines, therefore the capacitance value of the clock and data transmission line will not rise significantly when the cable is used for a long distance application (over 20 meters), avoiding erroneous recognition of HDMI signal.

Further, each high-frequency A/V transmission line comprises a twisted pair of high-frequency transmission wires, an aluminum foil layer surrounding the twisted pair of high-frequency transmission wires, a high-frequency grounding wire arranged outside the aluminum foil layer in a parallel manner relative to the twisted pair of twisted pair of high-frequency transmission wires, and a shielding mylar (polyethylene terephthalate polyester film) layer surrounding the high-frequency grounding wire and the aluminum foil layer. Because the aluminum foil layer surrounds the twisted pair of high-frequency transmission wires and isolates the twisted pair of high-frequency transmission wires from the high-frequency grounding wire, the invention avoids surface damage of the high-frequency transmission wires by the high-frequency grounding wire during twisting of the high-frequency transmission wires with the high-frequency grounding wire. Therefore, the high-frequency transmission wires achieve high data transmission speed.

### BRIEF DESCRIPTION OF THE DRAWINGS

FIG. 1 is a cutaway view of a cable made according to the present invention.

FIG. 2 is a top view of FIG. 1.

FIG. 3 is a schematic drawing showing an application example of the cable according to the present invention.

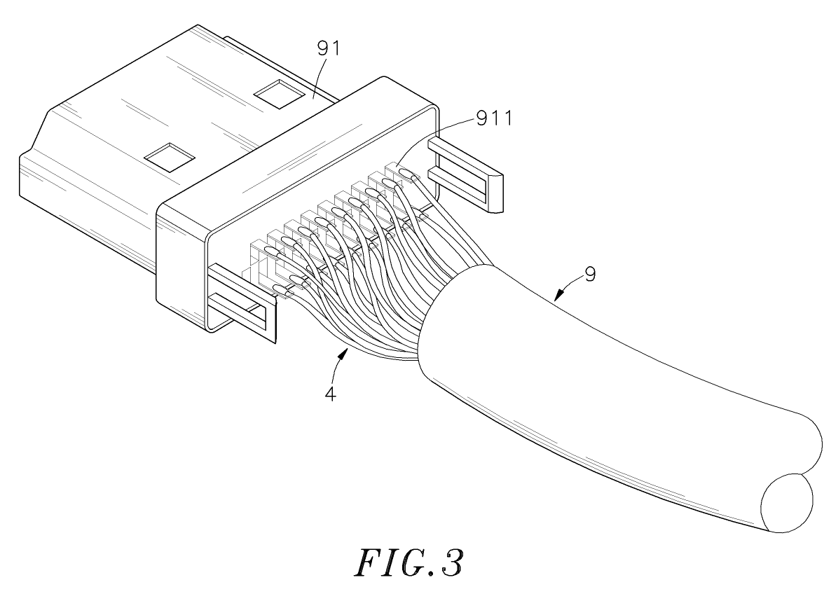

### DETAILED DESCRIPTION OF THE PREFERRED EMBODIMENT

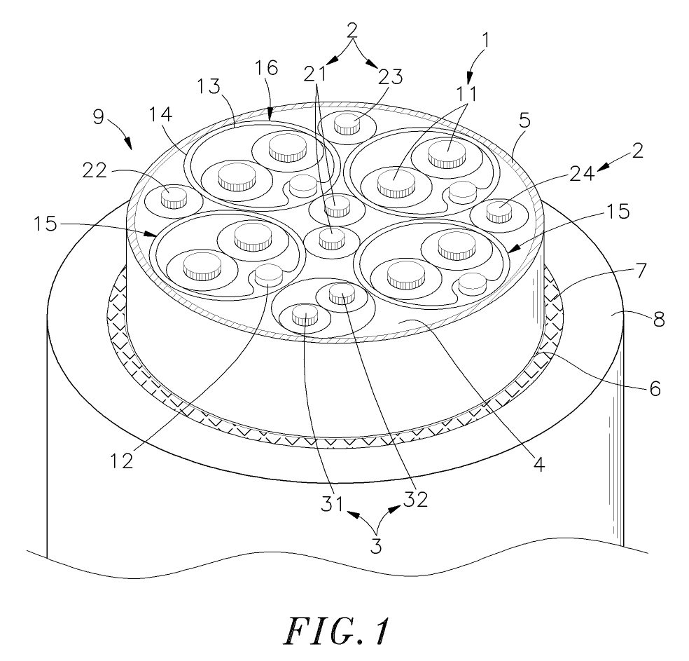

Referring to FIGS. 1˜3, a cable 9 with shielding arrangement in accordance with the present invention is shown comprising four high-frequency A/V transmission lines 1, a plurality of low-frequency transmission lines 2 and a power line 3.

Each high-frequency A/V transmission line 1 comprises a twisted pair of high-frequency transmission wires 11, an aluminum foil layer 13 surrounding the twisted pair of high-frequency transmission wires 11, a high-frequency grounding wire 12 arranged outside the aluminum foil layer 13 in a parallel manner relative to the twisted pair of high-frequency transmission wires 11, and a shielding mylar (polyethylene terephthalate polyester film) layer 14 surrounding the high-frequency grounding wire 12 and the aluminum foil layer 13. The four high-frequency A/V transmission lines 1 are divided into three A/V transmission lines 15 and one data recognition line 16.

The low-frequency transmission lines 2 include two clock and data transmission lines 21 surrounded by the four high-frequency A/V transmission lines 1, a consumer electronic data transmission line 22 arranged between the data recognition line 16 and a first of the A/V transmission lines 15 at an outer side relative to the two clock and data transmission lines 21, a spare line 23 arranged between the data recognition line 16 and a second of the A/V transmission lines 15 at an outer side relative to the two clock and data transmission lines 21, and a hot-plug transmission line 24 arranged between the second of the A/V transmission lines 15 and a third of the A/V transmission lines 15 at an outer side relative to the two clock and data transmission lines 21.

The power line 3 is arranged between the second and third of the A/V transmission lines 15 at an outer side relative to the two clock and data transmission lines 21, comprising a positive-pole power wire 31 and a negative-pole power wire 32. The negative-pole power wire 32 is grounded.

The four high-frequency A/V transmission lines 1, the low-frequency transmission lines 2 and the power line 3 are arranged into an electrical strand 4. The high-frequency A/V transmission lines 1, the low-frequency transmission lines 2 and the power line 3 are colored with different colors for quick discrimination. The cable 9 further comprises a shielding layer 5 that surrounds the electrical strand 4, a tin foil layer 6 that surrounds the shielding layer 5, a braided layer 7 that surrounds the tin foil layer 6, and an outer plastic sheath 8 that surrounds the braided layer 7.

The high-frequency A/V transmission lines 1 are adapted for transmitting high-frequency audio video signals. The shielding layer 5 is a thin transparent layer of light material prepared from, for example, Mylar polyester film, PET film or cotton paper, wrapped about the electrical strand 4 within the tin foil layer 6 to provide a good shielding effect. When splitting the cable 9, cut off the outer plastic sheath 8, the braided layer 7 and the tin foil layer 6 subject to the selected length, and then strip off the shielding layer 5, and then spread out the high-frequency A/V transmission lines 1, low-frequency transmission lines 2 and power line 3 of the electrical strand 4 for bonding to respective pins 911 of an electrical connector 91 that is connectable to a media player for audio and video signal output.

By means of the shielding effect of the shielding layer 5 to shield the high-frequency A/V transmission lines 1 and the low-frequency transmission lines 2 against interference, the cable 9 is practical for a long distance application (over 20 meters) without causing any rise in capacitance value. Therefore, when the cable 9 is used for a long distance application (over 20 meters), it transmits audio and video signals stably without causing signal distortion.

As stated above, the invention provides a cable 9 comprising an electrical strand 4 formed of four high-frequency A/V transmission lines 1, multiple low-frequency transmission lines 2 and a power line 3, a shielding layer 5 surrounding the electrical strand 4, a tin foil layer 6 surrounding the shielding layer 5, a braided layer 7 surrounding the tin foil layer 6, and an outer plastic sheath 8 surrounding the braided layer 7, wherein the shielding layer 5 is thin transparent layer of light material that provides an excellent shielding effect so that the cable 9 is practical for a long distance application (over 20 meters) without causing any rise in capacitance value.

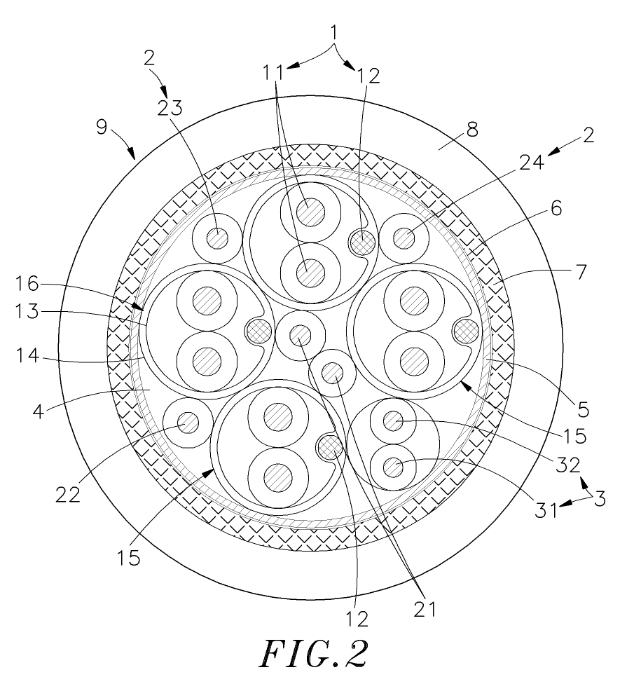

Referring to FIGS. 1 and 2 again, the aluminum foil layer 13 surrounds the twisted pair of high-frequency transmission wires 11 and isolates the twisted pair of high-frequency transmission wires 11 from the high-frequency grounding wire 12, avoiding surface damage of the high-frequency transmission wires 11 by the high-frequency grounding wire 12 during twisting of the high-frequency transmission wires 11 with the high-frequency grounding wire 12. Because transmission of high-frequency signal is done by means of skin effect, surface damage of the high-frequency transmission wires 11 will cause data transmission to be slowed down or stopped. By means of the aluminum foil layer 13 to isolate the twisted pair of high-frequency transmission wires 11 from the high-frequency grounding wire 12, the surface of the aluminum foil layer 13 surrounds the twisted pair of the high-frequency transmission wires 11 is well protected, assuring high data transmission speed of the cable 9.

Further, if the capacitance value of the clock and data transmission line 21 surpasses the standard value (700 pf), the electronic device at the receiving side of the cable 9 will erroneously regard HDMI signal as DVI signal. The invention eliminates this problem. Because the clock and data transmission lines 21 are surrounded by the four high-frequency A/V transmission lines 1, the distance between each clock and data transmission line 21 and the tin foil layer 6 is relatively longer than the other low-frequency transmission lines 2. Further, the shielding layer 5 surrounds the electrical strand 4 within the tin foil layer 6. Therefore, the capacitance value of the clock and data transmission line 21 will not rise significantly when the cable 9 is used for a long distance application (over 20 meters), avoiding erroneous recognition of HDMI signal.

In conclusion, the invention has the following features and advantages:

1. The electrical strand 4 of the cable 9 is formed of four high-frequency A/V transmission lines 1, multiple low-frequency transmission lines 2 and one power line 3, and surrounded by the shielding layer 5 within the tin foil layer 6. Therefore, the clock and data transmission lines 21 are isolated from the tin foil layer 6 by the shielding layer 5, and the tin foil layer 6 is prohibited from interfering with data transmission of the clock and data transmission lines 21, i.e., the cable 9 is practical for a long distance application (over 20 meters) without causing any rise in capacitance value.

2. The shielding layer 5 of the cable 9 has thin and light characteristics and is easily strippable so that the high-frequency A/V transmission lines 1, low-frequency transmission lines 2 and power line 3 of the electrical strand 4 can quickly be spread out for bonding during installation of the cable 9.

3. The shielding layer 5 of the cable 9 provides an excellent shielding effect to prevent signal interference, assuring high A/V signal transmission stability.

4. The two clock and data transmission lines 21 of the low-frequency transmission lines 2 are surrounded by the four high-frequency A/V transmission lines 1, the distance between each clock and data transmission line 21 and the tin foil layer 6 is relatively longer than the other low-frequency transmission lines 2, therefore the capacitance value of the clock and data transmission line 21 will not rise significantly when the cable 9 is used for a long distance application (over 20 meters), avoiding erroneous recognition of HDMI signal.

5. The aluminum foil layer 13 surrounds the twisted pair of high-frequency transmission wires 11 and isolates the twisted pair of high-frequency transmission wires 11 from the high-frequency grounding wire 12, avoiding surface damage of the high-frequency transmission wires 11 by the high-frequency grounding wire 12 during twisting of the high-frequency transmission wires 11 with the high-frequency grounding wire 12. Therefore, the high-frequency transmission wires 11 achieve high data transmission speed.

A prototype of cable with shielding means has been constructed with the features of FIGS. 1˜3. The cable with shielding means functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A cable comprising an electrical strand, a shielding layer surrounding said electrical strand, a tin foil layer surrounding said shielding layer, a braided layer surrounding said tin foil layer, and an outer plastic sheath surrounding said braided layer, wherein said electrical strand comprises four high-frequency A/V transmission lines, a plurality of low-frequency transmission lines and a power line, each said high-frequency A/V transmission line comprising a pair of high-frequency transmission wires, an aluminum foil layer surrounding said pair of high-frequency transmission wires, a high-frequency grounding wire arranged outside the aluminum foil layer in a parallel manner relative to said pair of high-frequency transmission wires, and a shielding Mylar layer surrounding said high-frequency grounding wire and said aluminum foil layer, said four high-frequency A/V transmission lines being divided into three A/V transmission lines and one data recognition line, said low-frequency transmission lines comprising two clock and data transmission lines surrounded by said four high-frequency A/V transmission lines, a consumer electronic data transmission line, a spare line, and a hot-plug transmission line.

2. The cable as claimed in claim 1, wherein said pair of high-frequency transmission wires of said four high-frequency A/V transmission lines are a twisted pair.

3. The cable as claimed in claim 1, wherein said power line is arranged between the second and third of the A/V transmission lines at an outer side relative to the two clock and data transmission lines

4. The cable as claimed in claim 1, wherein said power line comprises a positive-pole power wire and a negative-pole power wire, said negative-pole power wire being grounded.

5. The cable as claimed in claim 1, wherein the shielding layer that surrounds said electrical strand is prepared from one of the materials of Mylar polyester film, PET film and cotton paper.

6. The cable as claimed in claim 1, wherein said consumer electronic data transmission line is arranged between said data recognition line and a first of said A/V transmission lines at an outer side relative to said two clock and data transmission lines,

7. The cable as claimed in claim 1, wherein said spare line is arranged between said data recognition line and a second of said A/V transmission lines at an outer side relative to said two clock and data transmission lines.
The cable as claimed in claim 1, wherein said hot-plug transmission line is arranged between said second of said A/V transmission lines and a third of said A/V transmission lines at an outer side relative to said two clock and data transmission line.
